(19) United States
(12) Patent Application Publication
(10) Pub. No.: US 2018/0358604 A1
(43) Pub. Date: Dec. 13, 2018

(54) SELF-CLEANING BATTERY TERMINALS

(71) Applicant: Floyd L. Wilson, Manhattan, KS (US)

(72) Inventor: Floyd L. Wilson, Manhattan, KS (US)

(21) Appl. No.: 15/617,653

(22) Filed: Jun. 8, 2017

(51) Int. Cl. H01M 2/32; H01M 2/10; H01M 2/30

(52) U.S. Cl. CPC H01M 2/32; H01M 2/30; H01M 2/1055

(57) ABSTRACT

A battery powered device has a device battery receptacle with device terminals therein. A battery with battery terminals is received within the receptacle with the battery terminals electrically engaging the device terminals. Either the battery terminals or the device terminals are provided with a cleaning surface characteristic which tends to remove any electrical contact interfering substance on the other set of terminals to thereby enable establishment of electrical contact between the sets of terminals.

### BACKGROUND OF THE INVENTION

The present invention is broadly concerned with improvements in devices with replaceable batteries and, more particularly, to improvements in battery terminals and battery receptacle terminals.

A great many devices are powered by batteries. The devices may be designed for the use of rechargeable batteries or by so-called primary batteries which function until the chemical elements generating electrical currents are exhausted. Such batteries are then replaced, typically by the user of the device. Batteries are received in a battery receptacle of a device with anodes (positive terminals) and cathodes (negative terminals) electrically engaged with appropriate device or receptacle terminals of the device.

A common problem with batteries having terminals which bear against or directly contact device terminals is corrosion of the battery terminals, the device terminals, or both. Terminal corrosion is much less of a problem with batteries which use soldered connections. However, batteries using soldered connections are rarely used in devices with consumer replaceable batteries. Terminal corrosion is especially a problem for devices which are used in humid, dusty, or smoky environments. When battery terminal corrosion occurs, performance of the device may deteriorate, become unreliable, or fail. Electrical continuity between battery and device terminals can be interfered with by other substances which are not necessarily corrosive, such as dust, smoke, and oil particles, and the like.

A common technique for overcoming suspected contact problems between battery and device terminals is to remove the battery and reinsert it into the device receptacle. However, batteries are often replaced unnecessarily when the battery or batteries do not appear to function when the problem is actually an occurrence of contact resistance.

### SUMMARY OF THE INVENTION

The present invention provides embodiments of improvements battery powered apparatus with replaceable batteries which overcome some of the contact problems associated with such devices. In an embodiment of the apparatus, a battery-operated device having a battery receptacle with a set of device receptacle terminals is adapted to receive a battery having a set of battery terminals corresponding to the receptacle terminals and electrically engaging the receptacle terminals upon placement of the battery in the receptacle. A first of the sets of terminals has respective contact surfaces with a surface characteristic such that placement of the battery in the battery receptacle engages the first set of terminals with the other set of terminals in such a manner as to establish electrical contact therewith through an electrical contact interfering substance, if present on a terminal of the other set of terminals. The surface characteristic provided on the first or cleaning set of terminals may be a slight abrasiveness or roughening of the surface of the cleaning terminals, as by scoring, knurling, or the like or by a somewhat abrasive surface finish. The degree of abrasiveness or roughening is slight in order to avoid undesired wearing between the sets of terminals.

The cleaning set of terminals may be the positive and negative electrodes of the battery. Alternatively, the cleaning set of terminals may be receptacle contacts present in the battery-operated device. The cleaning set of terminals may establish contact with the other set of contacts by removing the electrical contact interfering substance, such as corrosion or the like, from one or both of the other set of terminals.

Various objects and advantages of the present invention will become apparent from the following description taken in conjunction with the accompanying drawings wherein are set forth, by way of illustration and example, certain embodiments of this invention.

The drawings constitute a part of this specification, include exemplary embodiments of the present invention, and illustrate various objects and features thereof.

### BRIEF DESCRIPTION OF THE DRAWINGS

FIG. 1 is a fragmentary perspective view of a battery-operated device showing a battery removed from a battery receptacle of the device.

FIG. 2 is a fragmentary top plan view of the device with a battery shown inserted in the battery receptacle thereof.

FIG. 3 is a somewhat enlarged end view of a battery, taken on line 3-3 of FIG. 1, and shows a battery anode terminal with a device terminal cleaning characteristic.

FIG. 4 is a view similar to FIG. 3, taken on line 4-4 of FIG. 1, and shows a battery cathode terminal with a device terminal cleaning characteristic.

FIG. 5 is a somewhat enlarged cross sectional view, taken on line 5-5 of FIG. 1, and shows an alternative device anode terminal with a battery terminal cleaning characteristic thereon.

FIG. 6 is a view similar to FIG. 5, taken on line 6-6 of FIG. 1, and shows an alternative device cathode terminal with a battery terminal cleaning characteristic thereon.

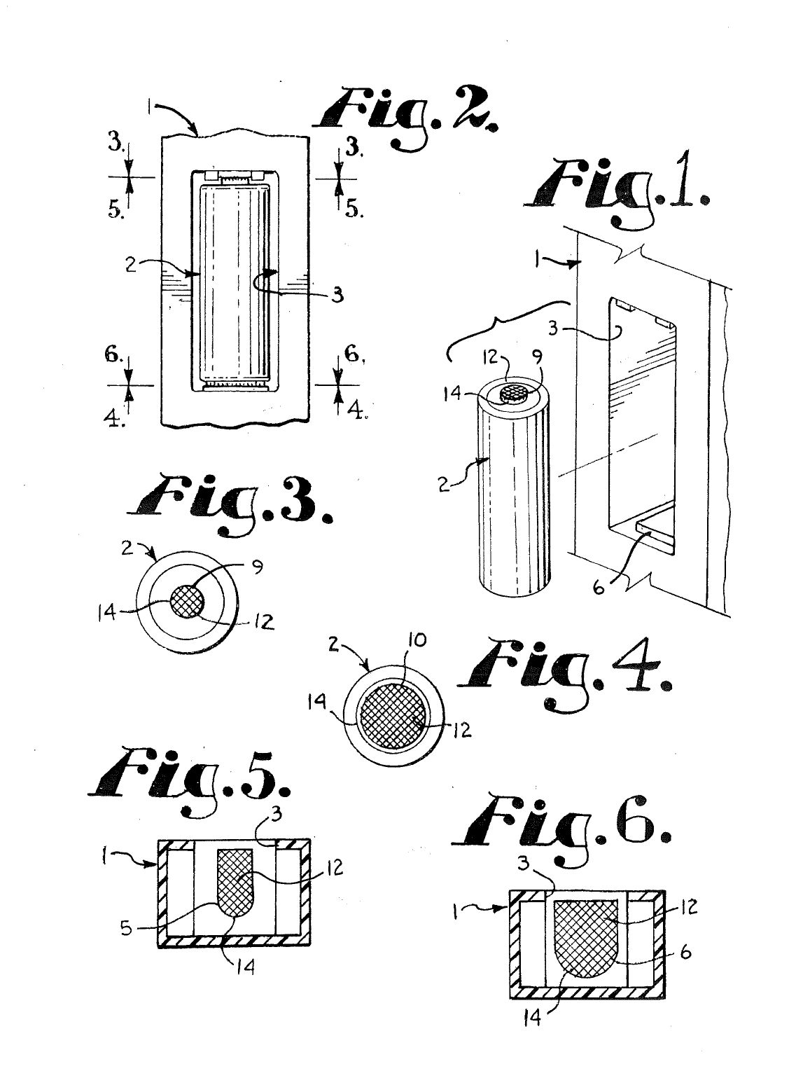

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 1 generally designates an embodiment of a battery powered device which receives a battery 2 within a device battery receptacle 3 thereof to power functions of the device 1. The device 1 has device terminals 5 (FIG. 5) and 6 (FIG. 6), while the battery 2 has battery terminals 9 (FIG. 3) and 10 (FIG. 4).

The battery terminals 9 and 10 electrically engage the respective device terminals 5 and 6 when the battery 2 is placed properly in the battery receptacle 3.

In the present invention, either the battery terminals 9 and 10 or the device terminals 5 and 6 is provided with a terminal surface characteristic or cleaning characteristic 12 (indicated by cross hatching in the drawings) which enhances electrical continuity between the engaging battery and device terminals when the battery 2 is placed in the battery receptacle 3 of the device 1. The terminals which are provided with the terminal surface cleaning characteristic 12 are referred to as cleaning terminals 14. It is foreseen that both the battery terminals 9 and 10 and the device terminals 5 and 6 could be provided with the surface characteristic 12.

The terminal surface characteristic 12 preferably is provided with a slight abrasiveness which causes the cleaning terminals 14 to scrape through any electrically interfering substance which may be present on the terminals engaged by the cleaning terminal 14. The abrasiveness of the surface characteristic may be provided by scoring, knurling, or the like of the cleaning terminals 14 or by a somewhat rough or abrasive surface finish on the cleaning terminals 14. The degree of abrasiveness on the cleaning terminals 14 is preferably only high enough to enhance electrical contact between the cleaning terminals 14 and the terminals engaged by the cleaning terminals, but low enough to avoid undesired wearing away of the terminals engaged by the cleaning terminals.

FIGS. 3 and 4 illustrate the terminal cleaning characteristic 12 formed on the anode (positive terminal) 9 and cathode (negative terminal) 10 of the battery 2 whereby the battery terminals 9 and 10 are designated the cleaning terminals 14. The battery cleaning terminals 9 and 10 respectively engage the device terminals 5 and 6 when the battery 2 is placed correctly in the device battery receptacle 3 of the device 1. Placement of the battery 2 in the receptacle 3 frictionally engages the cleaning terminals 14 with the device terminals 5 and 6 which tends to scrape away any contact interfering substance (not shown) present on the device terminals 5 and 6, thereby improving electrical contact between the battery contacts 9 and 10 and the device terminals 5 and 6.

In an alternative embodiment shown in FIGS. 5 and 6, the cleaning characteristic 12 is provided on the device contacts 5 and 6 whereby the device contacts are designated the cleaning terminals 14. When a battery 2 is placed in the device battery receptacle 3, the cleaning terminals 14 frictionally engage the battery terminals 9 and 10, thereby scraping away any contact interfering substance which might be present on the battery terminals 9 and 10.

It is to be understood that while certain forms of the present invention have been described and illustrated herein, it is not to be limited to the specific forms or arrangement of parts described and shown.

What is claimed and desired to be secured by Letters Patent is:

1. In a combination of a battery powered device having a battery receptacle with a set of device receptacle terminals and a battery having a set of battery terminals corresponding to the receptacle terminals and electrically engaging the receptacle terminals upon placement of the battery in the receptacle, the improvement comprising:
(a) a first set of the sets of terminals having respective contact surfaces with a surface characteristic such that placement of the battery in the battery receptacle engages the first set of terminals with the other set of terminals in such a manner as to establish electrical contact therewith through an electrical contact interfering substance if present on a terminal of the other set of terminals.

2. A combination as set forth in claim 1 wherein:
(a) the surface characteristic is roughened contact surfaces of the first set of terminals.

3. A combination as set forth in claim 1 wherein:
(a) the surface characteristic is scored contact surfaces of the first set of terminals.

4. A combination as set forth in claim 1 wherein:
(a) the surface characteristic is knurled contact surfaces of the first set of terminals.

5. A combination as set forth in claim 1 wherein:
(a) the surface characteristic is provided on the battery terminals.

6. A combination as set forth in claim 1 wherein:
(a) the surface characteristic is provided on the device terminals.

7. A battery unit adapted for replaceable reception in a device having device terminals and comprising:
(a) an electrical battery having battery terminals; and
(b) the battery terminals having respective surfaces with a surface characteristic such that placement of the battery in a device engages the battery terminals with corresponding device terminals in such a manner as to remove an electrical contact interfering substance from the device terminals.

8. A battery unit as set forth in claim 7 wherein:
(a) the surface characteristic is roughened contact surfaces of the battery terminals.

9. A battery unit as set forth in claim 7 wherein:
(a) the surface characteristic is scored contact surfaces of the battery terminals.

10. A battery unit as set forth in claim 7 wherein:
(a) the surface characteristic is knurled contact surfaces of the battery terminals.

11. In battery powered device including a battery receptacle having a set of device receptacle terminals and adapted to receive a battery with a set of battery terminals, the improvement comprising:
(a) the device receptacle terminals having a surface characteristic such that placement of a battery in the battery receptacle engages battery terminals thereof with corresponding device terminals in such a manner as to remove an electrical contact interfering substance from battery terminals of the battery.

12. A device as set forth in claim 11 wherein:
(a) the surface characteristic is roughened contact surfaces of the device terminals.

13. A device as set forth in claim 11 wherein:
(a) the surface characteristic is scored contact surfaces of the device terminals.

14. A device as set forth in claim 11 wherein:
(a) the surface characteristic is knurled contact surfaces of the device terminals.
